(19) United States
(12) Patent Application Publication
(10) Pub. No.: US 2004/0150235 A1
(43) Pub. Date: Aug. 5, 2004

(54) Protection piece, in particular for a motor vehicle, a bodywork assembly, and a bodywork part

(75) Inventors: Olivier Cornet, Ceyzeriat (FR); Stephanie Ader, Ambronay (FR); Francois Trocherie, Meximieux (FR); Stephane Malteste, Meximieux (FR)

Correspondence Address: OLIFF & BERRIDGE, PLC, P.O. BOX 19928, ALEXANDRIA, VA, 22320, US

(73) Assignee: COMPAGNIE PLASTIC OMNIUM, Lyon (FR)

(21) Appl. No.: 10/627,818

(22) Filed: Jul. 28, 2003

(30) Foreign Application Priority Data
Jul. 26, 2002 (FR) 0209576

(51) Int. Cl. B60R 19/42

(52) U.S. Cl. 293/128

(57) ABSTRACT

The invention provides a protection piece for protecting a side bodywork part. It possesses both a side wall suitable for covering at least part of the side bodywork part and a flap for extending towards the side bodywork part, the flap being arranged in such a manner as to be capable of retracting so as to allow the wall of said protection piece to move towards the side bodywork part in such a manner that in the event of contact with an obstacle and for forces below a predetermined threshold only the protection piece is deformed, thereby preserving the side bodywork piece. The invention also provides a bodywork assembly and a bodywork part.

The present invention relates to a protection piece, in particular for a motor vehicle, to a bodywork assembly, and to a bodywork part.

### BACKGROUND OF THE INVENTION

Bodywork parts made of thermoplastic material are known that, amongst numerous advantages, present the advantage of being able to accommodate a small amount of deformation without breaking and of returning to their initial shape elastically.

Unfortunately, such bodywork parts are not always suitable since a certain amount of stiffness is sometimes preferred for certain portions of a vehicle.

That is why bodywork parts made of sheet metal continue to be used, in particular for doors, and for front or rear fenders. Sheet metal is sometimes replaced by a structure of thermosetting material such as sheet molding compound (SMC) which is made of polyester.

A drawback of stiff bodywork parts is that they can be damaged in the event of small impacts that are of no consequence for the structure of the vehicle or for the safety of its passengers, but that nevertheless give rise to repair costs which are required solely for reasons of appearance. This applies in particular to side bodywork parts which are highly exposed to minor impacts, particularly against low obstacles such as sidewalk curbs or bollard posts.

### OBJECTS AND SUMMARY OF THE INVENTION

An object of the invention is to remedy those drawbacks by providing a protection piece that is capable of eliminating any need for repair.

To this end, the invention provides a protection piece for a side bodywork part, the piece possessing both a wall suitable for covering at least part of the side bodywork part and a flap for extending towards the side bodywork part, the flap being arranged to be capable of retracting so as to allow the wall of said protection piece to move towards the side bodywork part so that in the event of contact with an obstacle and for forces below a predetermined threshold only the protection piece is deformed, thereby preserving the side bodywork part.

Thus, by means of the invention, retraction of the flap of the protection piece allows the protection piece to deform under the action of the obstacle without subjecting the side bodywork part to stresses that are likely to damage it.

The side bodywork part can thus accommodate small side impacts without it being necessary to perform expensive repairs.

A protection piece of the invention for a side bodywork part may further comprise one or more of the following characteristics:

the flap is arranged to retract by buckling;

the flap is arranged to retract by folding;

the flap is arranged to retract by advancing beyond the side bodywork part.

The invention also provides a motor vehicle bodywork assembly comprising a side bodywork part and a protection piece as described above.

A bodywork assembly of the invention may further comprise one or more of the following characteristics:

a support piece is provided for the protection piece;

the side bodywork part is a fender or an outside panel of a door;

the assembly further comprises fastener means for uniting the flap of the protection piece and the side bodywork part;

the fastener means are fusible;

the fusible fastener means are constituted by rivets made of plastics material;

the fusible fastener means are constituted by spot welds;

the side bodywork part presents a setback in register with the protection piece; and

the protection piece occupies the setback and appears to extend the side bodywork part.

The invention also provides a motor vehicle side bodywork part, presenting a setback directed towards the outside of the vehicle in order to receive a protection piece as described above.

### BRIEF DESCRIPTION OF THE DRAWINGS

The invention will be better understood on reading the following description given purely by way of example and made with reference to the accompanying drawings, in which:

FIG. 1 is an elevation view of the front of a vehicle in a first embodiment of the invention;

FIG. 2 is a section view on II-II of FIG. 1;

FIG. 3 is a view in perspective and in section showing a motor vehicle door in a second embodiment of the invention;

FIG. 4 is a section on IV-IV of FIG. 3 in a first variant;

FIG. 5 is a view analogous to FIG. 4 after making contact with an obstacle;

FIG. 6 is a view analogous to FIG. 4 in a second variant of this second embodiment;

FIG. 7 is a section through the bottom portion of a side bodywork part in a third embodiment of the invention;

FIG. 8 is a view analogous to FIG. 7 after making contact with an obstacle in a first variant; and

FIG. 9 is a view analogous to FIG. 8 showing a second variant of the third embodiment.

### MORE DETAILED DESCRIPTION

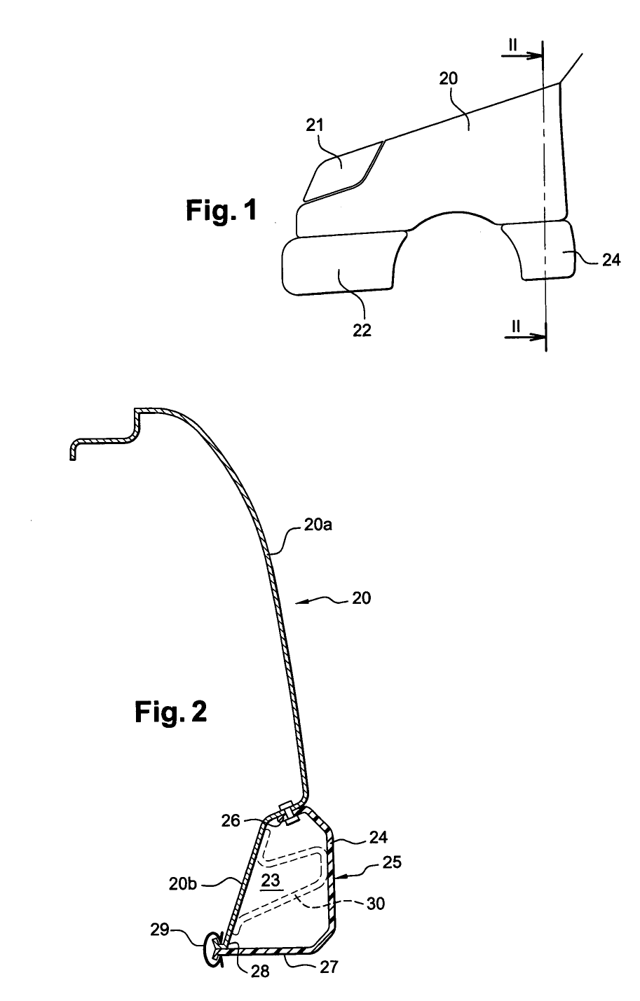

The first embodiment shown in FIGS. 1 and 2 relates to a motor vehicle front fender 20, with FIG. 1 showing a headlight unit 21 and a bumper shield 22.

In the section of FIG. 2, it can be seen that the fender 20 comprises a visible top portion 20a and a hidden bottom portion 20b which defines a setback directed towards the inside of the vehicle.

This setback forms a housing 23 in which a protective strip 24 is secured, constituting a protection piece of the invention.

As can be seen in FIG. 2, the protective strip 24 comprises a visible outside wall 25, a top rim 26 which is fixed to the fender 20 by riveting, and a bottom flap 27 whose free end is secured to the bottom edge 28 of the fender by means of a clip 29.

In accordance with the invention, the strip 24 acts as a protection piece for the side bodywork part constituted by the fender 20.

In the event of an impact against an obstacle causing the strip 24 to be pushed in (from right to left in FIG. 2), the flap can retract by detaching the clip 27 and moving beyond the edge 28 of the fender, towards the inside of the vehicle.

The top rim 26 of the strip 24 remains fixed to the fender by means of the rivet, and the strip bends, enabling its wall 25 to move closer to the hidden portion 20b of the fender.

So long as the strip 24 remains within its elastic region, it subsequently returns elastically to its initial shape, and repair requires no more than putting the clip 29 back into place so as to hold the free end of the flap 27 to the bottom edge 28 of the fender.

If, at worst, the strip 24 is broken, then only the strip needs to be replaced.

In any event, the fender 20 is spared and can be conserved.

It should also be observed that even in the event of the fender being deformed to a small extent, a new strip replacing the damaged strip can serve to mask any visible damage to the fender, so that providing the other functions of the fender are unimpaired, a fender whose hidden portion 20b has been deformed can be retained, thereby keeping repair costs down to replacing only the strip.

FIG. 2 also shows in dashed lines a support piece 30 for improving the strength of the strip 24, in particular the top portion thereof, in order to limit any kinking effect. Thus, a user of a vehicle causing pressure to be exerted on the strip is in no danger of indenting it too easily.

The support part 30 is dimensioned in such a manner as to avoid interfering with the operation of the strip 24 as described above.

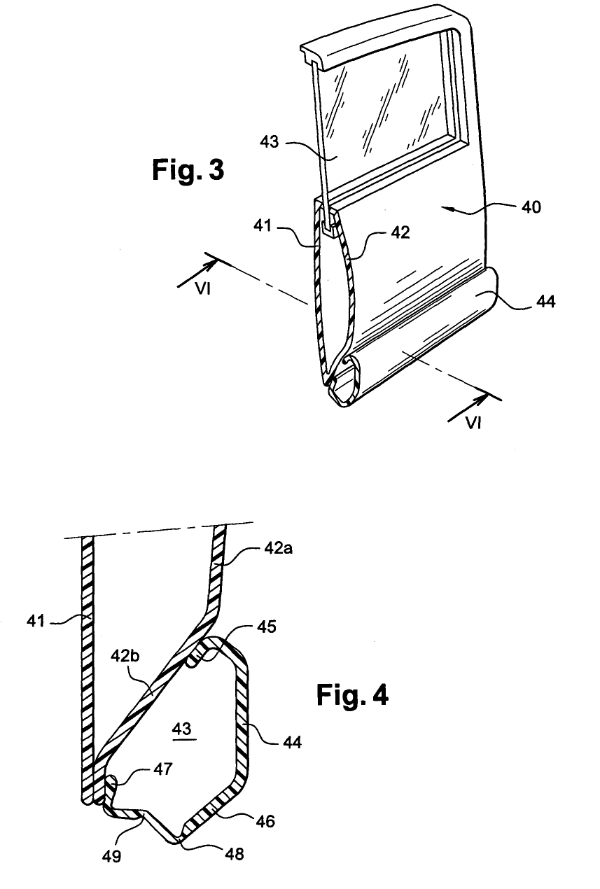

In the second embodiment, shown in FIGS. 3 to 6, a door 40 comprises a structural member which is deliberately shown in simplified form as an inside wall 41, an outside wall 42, and a window 43.

As can be seen more clearly on FIGS. 4 to 6, the wall 42 constitutes a side bodywork part having a visible top portion 42a and a hidden bottom portion 42b which defines a housing 43 receiving a protection strip 44.

This strip 44 includes a top rim 45 which is fixed by fasteners (not shown) to the outside wall 42 of the door, and a bottom flap 46 terminated by a rim 47.

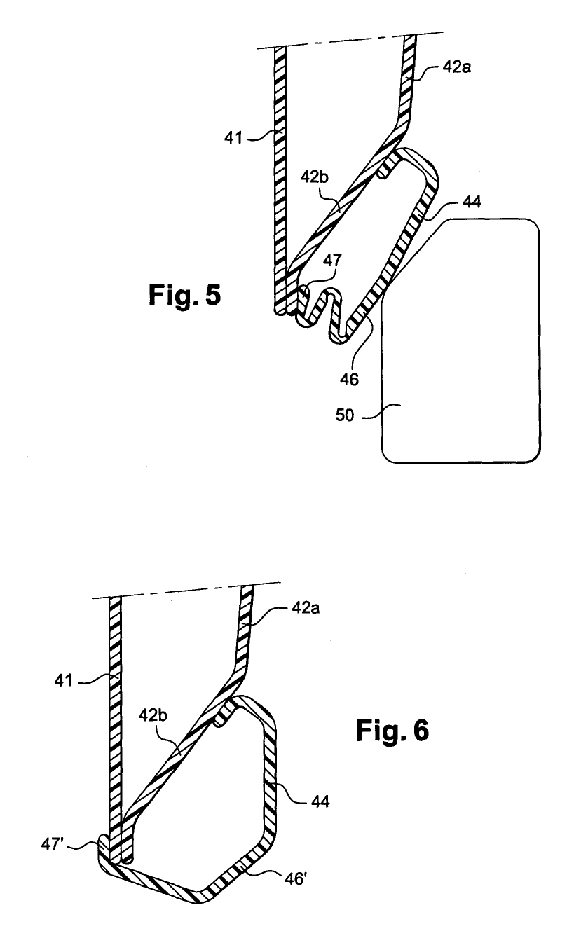

In the first variant corresponding to FIGS. 4 and 5, the rim 47 is secured by fasteners (not shown) to the bottom end of the wall 42, and the flap 46 has two portions of reduced section 48, 49 which form weakened fold zones.

Thus, as can be seen in FIG. 5, when an obstacle 50 bears against the strip 44, the flap 46 retracts by folding, thus enabling the outside wall of the strip to move towards the wall 42 of the door.

In the variant of FIG. 6, the rim 47′ is not fixed to the bottom end of the door. It is merely pressed against the bottom edge of the inside wall 41 of the door solely by the elasticity of the strip 44.

As a result, in the event of thrust being exerted by an obstacle, the strip deforms and the flap 46′ retracts, passing under the bottom ends of the walls 41 and 42 of the door towards the inside of the vehicle.

So long as deformation is purely elastic, the strip 44 will subsequently return to its initial position and the rim 47′ will again press against the wall 41 of the door.

If the strip is deformed to a greater extent, then it will break and needs to be replaced.

In this variant, any rubbing or vibration that occurs between the rim 47′ and the wall 41 can be dealt with by interposing a suitable gasket.

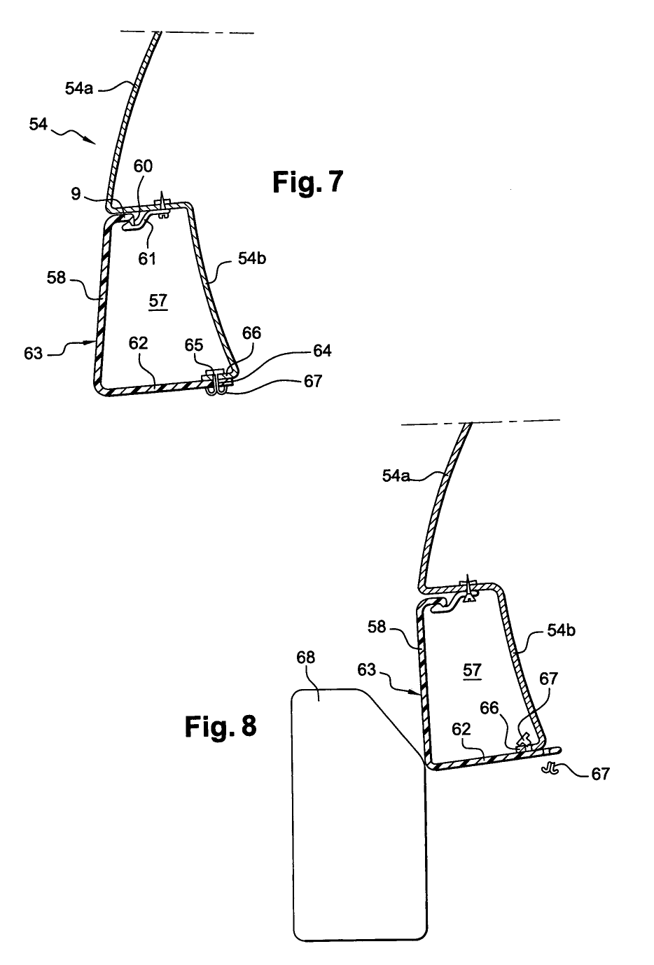

In the third embodiment shown in FIGS. 7 to 9, there can be seen a side bodywork part 54 of any kind which is provided with a protection strip 58 in its bottom portion. The side bodywork part 54 is made of metal and includes a housing 57 receiving the strip 58.

In section, the strip 58 is generally L-shaped having a top rim 59 terminated by a bead 60 enabling it to be snap-fastened in a retaining lug 61 screw-fastened to the metal part 54. The bottom of the strip 58 includes a flap 62 which extends substantially perpendicularly to its outside wall 63 towards the inside of the vehicle. At its free end, the flap 62 includes a through hole 74 which coincides with a through hole 65 formed in a rim 66 of the metal part. A fusible rivet 67, e.g. a rivet made of plastics material of the kind commonly sold under the name “plastirivet”, e.g. as sold by the supplier ITW, serves to unite the metal part 64 and the flap 62 via the two through holes 64 and 65.

In the rest position shown in FIG. 7, the wall 63 of the strip extends the visible portion 54a of the metal part.

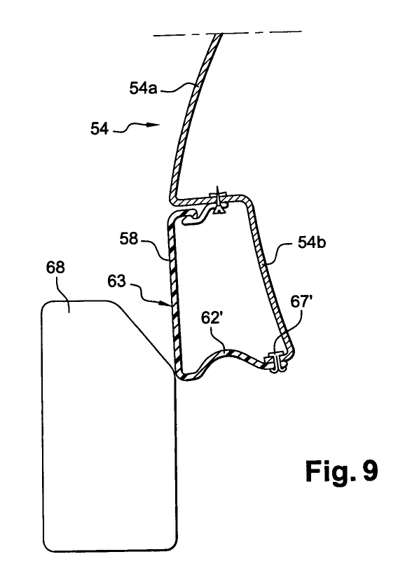

FIGS. 8 and 9 show how the strip 58 behaves in the event of coming into contact with an obstacle 18.

In the first variant shown in FIG. 8, the obstacle 68 begins by coming into contact with the strip 58.

Under pressure, the rivet 67 is subjected to shear and snaps, thereby releasing the flap 62 from the metal part 54.

As a result, the free end of the flap 62 can advance beyond the metal part 54 towards the inside of the vehicle, and the wall 63 can move into the housing 57 under thrust from the obstacle 68.

The rivet 67 is rated in such a manner as to snap under the shear that results from the flap 62 moving towards the inside of the vehicle before the force that it transmits to the metal part 54 reaches a threshold value at which it might damage said part.

Because the strip is separated from the metal part in this way as a result of the flap 62 retracting, the metal part 54 is not subjected to any damage while contact is being made with the obstacle.

Providing the strip deforms elastically, it will subsequently return to its initial shape and it suffices to replace the rivet 62 in order to restore the vehicle to its original appearance.

Otherwise, if the deformation imparted by the obstacle is too great, then the strip will break while leaving the metal part intact. The vehicle can be replaced merely by replacing the strip.

In any event, the more expensive parts are spared, and only the strip of thermoplastic material, which is of relatively low cost, needs to be replaced.

In the variant shown in FIG. 9, the rivet 67′ is not fusible, but the flap 62′ of the strip 58 is suitable for retracting by buckling.

As before, the wall 63 of the strip 58 can thus move back together with the obstacle 68.

In this variant, the flap 62′ of the strip is dimensioned and shaped in such a manner that buckling occurs at force levels that are below a threshold value above which the metal part 54 might be damaged.

As in the example of FIG. 8, the strip will return to its initial state providing the deformation to which it is subjected remains within its region of elasticity. Otherwise, the strip needs to be replaced, but the metal part 54 is spared.

What is claimed is:

1/ A protection piece for a side bodywork part, the piece possessing both a wall suitable for covering at least part of the side bodywork part and a flap for extending towards the side bodywork part, the flap being arranged to be capable of retracting so as to allow the wall of said protection piece to move towards the side bodywork part such that in the event of contact with an obstacle and for forces below a predetermined threshold only the protection piece is deformed, while the side bodywork part is preserved.

2/ A piece according to claim 1, in which the flap is arranged to retract by buckling.

3/ A piece according to claim 1, in which the flap is arranged to retract by folding.

4/ A piece according to claim 1, in which the flap is arranged to retract by advancing beyond the side bodywork part.

5/ A motor vehicle bodywork assembly comprising a side bodywork part and a protection piece according to claim 1.

6/ An assembly according to claim 5, including a support piece for the protection piece.

7/ An assembly according to claim 5, in which the side bodywork part is a fender.

8/ An assembly according to claim 5, in which the side bodywork part is an outside panel of a door.

9/ An assembly according to claim 5, further comprising fastener means for uniting the flap of the protection piece and the side bodywork part.

10/ An assembly according to claim 9, in which the fastener means are fusible.

11/ An assembly according to claim 10, in which the fusible fastener means are constituted by rivets made of plastics material.

12/ An assembly according to claim 10, in which the fusible fastener means are constituted by spot welds.

13/ An assembly according to claim 10, in which the side bodywork part presents a setback in register with the protection piece.

14/ An assembly according to claim 13, in which the protection piece occupies the setback and, seen from outside the vehicle, appears to extend the side bodywork part.

15/ A motor vehicle side bodywork part, presenting a setback on the outside of the vehicle in order to receive a protection piece according to claim 1.
